(19) United States
(12) Patent Application Publication
(10) Pub. No.: US 2005/0167467 A1
(43) Pub. Date: Aug. 4, 2005

(54) Device for positioning several sheets in a stapler

(76) Inventor: Samuel Sprich, Gumligen (CH)

Correspondence Address: BIRCH STEWART KOLASCH & BIRCH, PO BOX 747, FALLS CHURCH, VA, 22040-0747, US

(21) Appl. No.: 10/505,437

(22) PCT Filed: Feb. 24, 2003
(86) PCT No.: PCT/CH03/00136

(30) Foreign Application Priority Data
Feb. 24, 2002 (CH) 319/02

(51) Int. Cl. B25C 7/00

(52) U.S. Cl. 227/151; 227/154

(57) ABSTRACT

Disclosed is a device (100) for positioning several sheets in a stapler (200), comprising a holding element (101) mounted on the stapler (200), a paper stop (111) which is maintained by the holding element, and an adjusting mechanism for moving the paper stop (111) relative to the holding element (101). The position between the staple and the edge of the sheet, particularly the distance from and angle in relation to the edge, can be adjusted by means of the movable paper stop (111), whereby a large number of staplings can be made at an identical spot. The inventive device is handy, user-friendly, flexible and compact. In one embodiment, the inventive device is provided with a rotatable paper stop (111) in the form of the segment of a circle, at the ends of which flattened stops (120, 121) are arranged for guiding the sheets to be stapled.

### TECHNICAL FIELD

The invention relates to a device for positioning several sheets in a stapler, having a holder, which can be fitted on the stapler, and a paper stop, which is retained by the holder.

### PRIOR ART

It is customary for several associated sheets of paper to be stacked and stapled together in a corner or at the border by means of a stapler. Staplers include large stapling machines for stapling large quantities of documents, catalogs, brochures, prospectuses, etc., and also smaller, manually actuated or electric staplers for use in the office. The latter usually have two legs which can be moved in relation to one another, the top leg having means for storing and dispensing staples and the bottom leg having an anvil for bending back the staple once it has passed through the paper stack. Such commercially available staplers can be used, depending on the configuration, for stapling document stacks with a thickness of approximately 15-250 sheets. The location and the orientation of the staples can be freely selected. It is usually merely the case that a maximum distance between the stapling and a sheet border is predetermined by the length of the two legs.

For the purpose of stapling several, in particular, identical stacks of documents, the task, then, is to staple precisely aligned paper stacks so as to achieve a result which is satisfactory from the point of view of appearance and handling. It is likewise important for the distance and the angle between the stapling and the sheet border to be adapted to the use purpose of the stapled sheets. An excessively small distance between the stapling and sheet border is accompanied by the risk of the staple tearing out, and an excessively large distance makes it difficult for the sheets to be turned over and may result in it no longer being possible to see a part of the stapled sheets which has printing or writing on it. The angle between the staple and sheet border is important for turning over the sheets in that it predetermines a preferred folding-over direction perpendicularly to the lengthwise extent of the staple.

GB 2 225 271 A (Olave Solozabal Y Cia SA) discloses a manually actuated stapler which is arranged on a U-shaped holder. A guide bar which comprises positioning marks is fitted transversely on the holder. The documents which are to be stacked are positioned against these positioning marks, with the result that, when several identical stacks are stapled, the staples are always positioned in the same way. The lengthwise extent of the staples is parallel to the guide bar in each case and thus perpendicular to the sheet border which is positioned against a positioning mark.

U.S. Pat. No. 5,692,666 (G.B. Invedyne Inc.) relates to a guide for aligning a sheet stack for subsequent stapling. This guide comprises a base plate for supporting the sheets and two guides which are arranged vertically on the base plate and enclose a right angle. The sheets which are to be stacked are positioned against the guides and can thus be aligned precisely. The base plate has, in the region of the corner of the two guides, an aperture which is of just the right size for a commercially available stapler to be positioned therein. In the case of a first configuration, the aperture is located at an angle of 45° to the guides, that is to say the staple is set at a corresponding angle to the sheet border. In the case of the other configuration, the aperture is located parallel to one of the guides, that is to say the staple can be driven in parallel to the corresponding sheet border.

The known devices allow several document stacks to be stapled such that the staples are always set in the same position. Both devices, however, are unwieldy and require a large amount of space. In addition, they are inflexible, particularly U.S. Pat. No. 5,692,666, which predetermines the position of the staple such that it cannot be changed. GB 2 225 271 A is laborious to operate since the user has to meticulously ensure, for each document stack which is to be stapled, that the stack is positioned against the correct positioning mark.

### DESCRIPTION OF THE INVENTION

The object of the invention is to specify a device which is associated with the technical field mentioned in the introduction and which is user-friendly and flexible.

The solution to the object is defined by the features of claim 1. According to the invention, the device comprises an adjusting mechanism for adjusting the paper stop in relation to the holder.

An adjustable paper stop allows a high level of flexibility in respect of optional adjustability of the position between the stapling and the sheet border, in particular of the distance and the angle between the two. At the same time, it is no longer necessary, once the paper stop has been adjusted, for the user to check, during each stapling operation, that the paper has been positioned correctly, i.e., for example, whether the correct positioning mark has been used. The adjusting mechanism may allow a linear adjustment, e.g. by virtue of a groove and a rail guided therein, a rotation about an axis or both possibilities.

The adjusting mechanism advantageously comprises a latching mechanism for latching a plurality of predetermined latching positions between the paper stop and the holder. This predetermines a plurality of positions between the stapling and the sheet border. This makes it possible, even after a certain amount of time in which other stapling positions have been used, to relocate a certain stapling position and to staple document stacks in this way again. The predetermined positions may, in addition, correspond to certain preferred arrangements of staples which give rise, for example, to particularly durable stapling or good handling.

As an alternative, it is possible for the position between the paper stop and stapling to be adjusted in a stepless manner and secured, for example, with a screw. In order that the same position can be set a number of times, it is possible to arrange, for example, visible marks on the paper stop and/or on the holder.

The latching mechanism is advantageously formed by a resilient pressure-exerting component and a plurality of corresponding apertures along the paper stop. Each predetermined position matches up with one of the apertures. As soon as the paper stop assumes one of the positions, the resilient pressure-exerting component engages in the aperture and thus retains the paper stop in the desired position. In order to change the position again, the paper stop has to be subjected to a somewhat larger force, with the result that the pressure-exerting element leaves the aperture again. The force required is achieved, on the one hand, from the force of the spring used and, on the other hand, from the profile of the aperture and of that part of the pressure-exerting component which interacts with the aperture. It is advantageous, in particular, for both the aperture and the front part of the pressure-exerting component to be of conical design.

The latching means can also be formed, for example, by apertures along the paper stops and by a pin or a screw arranged on the holder, which can engage in the aperture.

The adjusting mechanism is preferably designed so as to allow optional adjustment of an angle between a border of a sheet positioned against the paper stop and a stapling produced by the stapler, with a predetermined distance between the stapling and the sheet border. This is because the preferred distance between the sheet border and stapling is a result of the two requirements which stipulate that the stapling should not be torn out but that, nevertheless, the largest possible amount of surface area of the paper of the stapled sheets is to be visible. This preferred distance is not particularly dependent on the material of the sheets or the size of the latter or on the thickness of the stack which is to be stapled or on the direction of text or images of the contents. It can thus be fixedly predetermined. The angle between the longitudinal direction of the staple and the sheet border, in contrast, determines the preferred folding-over direction of the pages. Depending on the page sequence and direction of images or text, this preferred direction may be different. The adjustability of the angle allows the stapling to be adapted to the respective requirements.

As an alternative, the paper stop may also be formed such that it is also (or only) possible to vary the distance between the sheet border and stapling. The distance can thus be adapted to the material and the number of sheets which are to be stapled.

The paper stop advantageously comprises the following:
a) an angular part in the form of a segment of a circle;
b) a fastening arm, which extends radially inward in the plane of the angular part from an angle bisector of the angular part and which, at a center point of the circle, comprises means for fastening the paper stop in a rotatable manner on the holder;
c) two stop components, which are arranged at ends of the angular part.

A stack of sheets is positioned against the two stop components by way of the two sides which are adjacent to the corner at which stapling is to take place. A different angular position of the staple in relation to the paper stack is achieved depending on the orientation of the paper stop relative to the holder, which is fitted on the stapler. The arrangement, in addition, saves space and materials and is user-friendly since the angular part in the form of a circle segment, as a result of its central fastening, always moves over the same circle. This also ensures that the distances between the staple and sheet borders are kept constant.

The paper stop may optionally be in some other form. The stop components may be connected for example directly, via rectilinear crosspieces, to the fastening at the center point of the turning circle. The paper stop, moreover, may have a single, relatively large stop component, which encloses a corner of the documents which are to be guided, or more than two stop components, in order to improve the guidance of the sheets further.

Latching elements are advantageously arranged on the angular part such that the angle between the stapling and the sheet border can be latched in at 0°, 45° and 90°. The customary staplings can be produced using these latching positions. An angle of 0° relative to the longitudinal-side sheet border, i.e. the staple being arranged parallel to the sheet border, is recommended if the sheets, as in the case of a book, are to be turned over via their longitudinal side. The rear side of the previous sheet can thus be read or viewed easily. An angle of 45° makes it possible, within certain limits, for sheets to be turned over both via the longitudinal side and via the transverse side, which is useful in the case of documents which contain pages both in landscape format and in portrait format. An angle of 90° in relation to the longitudinal side, that is to say parallel to the transverse side is advantageous when the pages, as in the case of a calendar, are to be turned over via the transverse side.

For certain applications, other latch-in angles may be desirable. The circle segment preferably has an angle of 210°-270°. The angle between the contact surfaces of the stop components in relation to a right-angled sheet is 270°. In accordance with the size and shape of the stop components, the angle of the circle segment may be selected to be smaller.

The stop components advantageously extend vertically upward in a column-like manner from the angular part and, on the paper side, are flattened for the purpose of guiding the sheets. The column-like form is ergonomically favorable and does not result in the standing surface area of the device being increased. The flattening assists the precise alignment of the paper stack by predetermining the direction of the two gripped sheet borders over a larger surface area.

As an alternative, the stop components may be configured to the entirely flat form, e.g. as plastic plates, the paper stacks which are to be guided butting against the vertically upright main surface thereof.

The holder is preferably designed such that it can be fastened on a conventional stapler. It is thus possible to continue using existing commercially available staplers, which usually have a long service life.

It is also possible, however, for the device to be fixed to a stapler at the factory.

The holder advantageously has a clamping element for fastening the device on the conventional stapler. Fastening is thus simplified since there is no need to use any tools. Moreover, the device can easily be removed again or fitted on another stapler.

The holder can be fitted on the stapler by means of a spring leaf or some other clamping element which is clamped in an aperture on the underside of the stapler. A tie fastening is likewise possible, as is fastening by pressing the holder into the underside of the stapler. As an alternative, the holder can be adhesively bonded, screwed or riveted to the stapler if it is to be used permanently with the stapler.

Further advantageous embodiments and combinations of features of the invention can be gathered from the following detailed description and the patent claims in their entirety.

### BRIEF DESCRIPTION OF THE DRAWINGS

In the drawings, which are used in order to explain the exemplary embodiment:

FIG. 1 shows a side view of the device according to the invention fitted on a stapler;

FIG. 2 shows a plan view of the device according to the invention fitted on a stapler;

FIG. 3 shows a front view of the device according to the invention fitted on a stapler;

FIG. 4 shows a side view of the holder of the device according to the invention;

FIG. 5 shows a plan view of the holder;

FIG. 6 shows a front view of the holder; and

FIG. 7 shows a plan view of the positioning angle of the device according to the invention.

It is basically the case in the figures that the same parts are provided with the same designations.

### METHODS OF IMPLEMENTING THE INVENTION

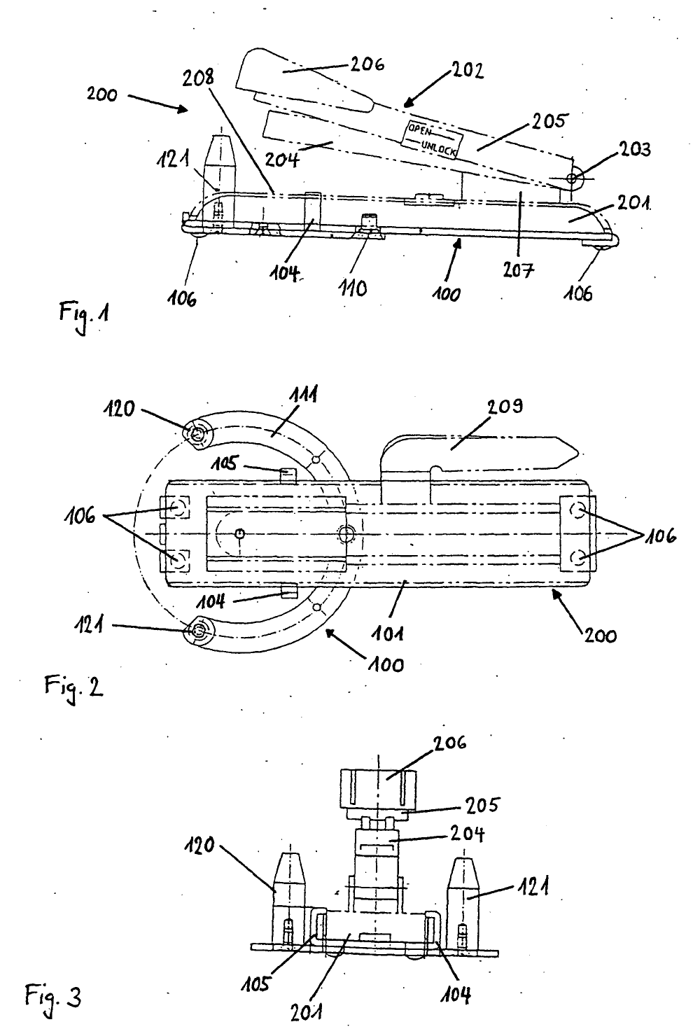

FIGS. 1-3 show different views of a device 100 according to the invention which is fitted on a commercially available stapler 200 for manual operation. The stapler 200 has two legs 201, 202 which can be moved in relation to one another and are connected via a hinge 203. The top leg 202, for its part, comprises a staple magazine 204 and a cover 205. At the front end, which is directed away from the hinge 203, a grip component 206 for actuating the stapler 200 is fitted on the cover 205. The hinge 203 is arranged in a retaining part 207 which is fastened on the bottom leg 201, which forms the standing surface of the stapler 200. The bottom leg 201 has, at its front end, an anvil 208 for bending back the staple once it has passed through the paper stack. It can be seen in the plan view of FIG. 2 that a device for removing staples 209 is arranged on the side of the stapler.

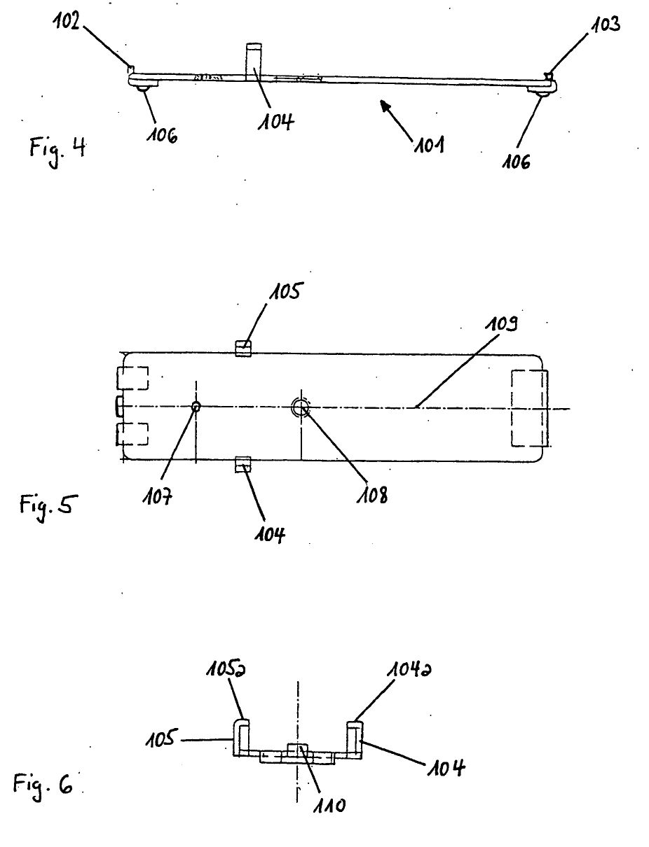

The holder 101 of the device 100 according to the invention for positioning several sheets is arranged on the underside of the stapler 200. It is illustrated more precisely in FIGS. 3-5. It is slightly longer than the length of the stapler 200, since it has, at its front and rear ends, retaining crosspieces 102, 103 which stand upright to a slight extent and between which the bottom leg 203 of the stapler 200 is arranged. They prevent the stapler 200 from slipping along the holder 101. The width of the holder 101 corresponds approximately to the width of the bottom leg 201, a flexible retaining clip 104, 105 extending upward on both sides in each case and projecting laterally beyond the holder 101 to a slight extent. Between the retaining clips 104, 105, which have an inwardly running section 104a, 105a at their top end, the holder 101 is fixed such that it cannot slide out laterally from beneath the stapler 200 or, when the stapler 200 is lifted up, fall downward. When the device 100 according to the invention is fitted and removed, the elastic retaining clips 104, 105 of the holder 101 are forced slightly outward, with the result that the stapler 200 can be drawn upward out of the holder 101.

On its underside, the holder 101 has, at its front and rear ends, in each case two rubber feet 106, which prevent slipping on the underlying surface.

The holder 101 is of a very flat configuration, with the result that the height of the stapler 200 is only raised to an insignificant extent by the positioning device 100 when fitted. The user-friendliness of the stapler 200 thus remains intact. The holder 101, in addition, has two circular openings 107, 108 along its center axis 109. The front opening 107 serves for accommodating a screw or a rivet, on which the fastening arm 113 of the positioning angle 111 is fastened in a rotatable manner. It is positioned approximately beneath the anvil 208 of the stapler 200. The rear opening 108 accommodates a resilient pressure-exerting component 110. It is spaced apart from the front opening 107 by a distance which corresponds precisely to the radius of the circle-segment-like positioning angle 111, and thus ends up located precisely centrally, in the radial direction, on the circle segment.

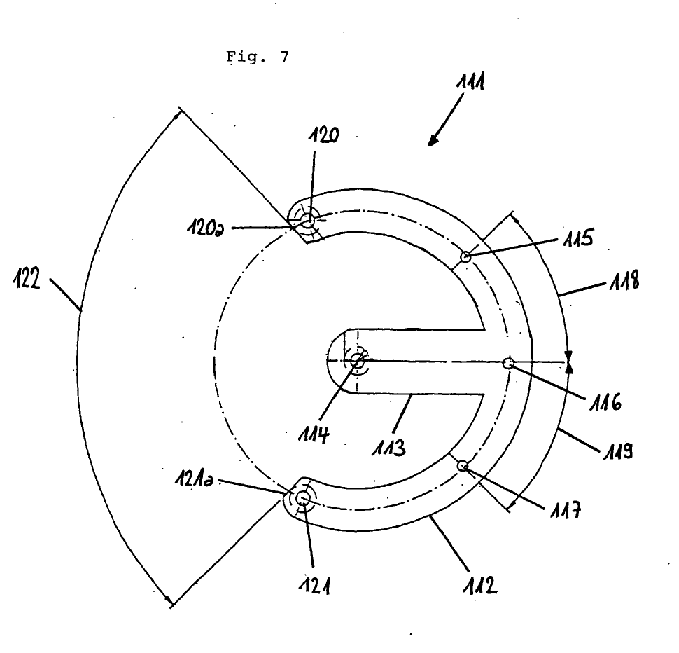

FIG. 7 shows a plan view of the positioning angle 111. The latter comprises an angular part 112 which is essentially in the form of a flat ring segment of approximately 225°. Arranged along the angle bisector of the angular part 112 is a fastening arm 113 which extends radially beyond the center point of the ring. The thickness of the angular part 112 and fastening arm 113 corresponds approximately to the thickness of the holder 101. The fastening arm 113 has an opening 114 at the center point of the ring. A screw or rivet engages through this opening, with the result that the positioning angle 111 can be fastened in a rotatable manner on the front opening 107 of the holder 101.

The angular part 112 has circular apertures 115, 116, 117 on its top side. The diameter of these apertures corresponds to the diameter of the resilient pressure-exerting component 110 of the holder 101. The apertures 115, 116, 117 interact with the pressure-exerting component 110 such that it is possible to latch three corresponding angular positions of the positioning angle 111. The central aperture 116 is arranged in extension of the fastening arm 113, and the outer apertures 115, 117 are at an angle 118, 119, in respect of the center point of the circle, in relation to the central aperture 116, these angles both being 45°.

Stop components 120, 121 which extend vertically upward are arranged at the outer ends of the angular part 112. The stop components 120, 121 have flattened portions 120a, 121a, these resulting in vertical contact surfaces for guiding a sheet which is to be stapled. The contact surfaces are symmetrical in relation to the ring and enclose an angle 112 of 90° in relation to one another, with the result that a stack of commercially available rectangular sheets can be guided.

If, then, the positioning angle 111 is latched in at the central aperture 116, the two guided sheet borders are each located at an angle of 45° in relation to the axis of the stapler 200. Since the staple is dispensed transversely to this axis, this results in stapling at an angle of 45° in relation to the sheet borders. If the positioning angle 111 is latched in at the outer aperture 115, the sheet border guided by the stop component 120 is parallel to the staple and the other sheet border, guided by the stop component 121, is perpendicular to the staple. The opposite is the case if the positioning angle is latched in at the other outer aperture 117.

To summarize, it may be stated that the invention provides a manageable, space-saving, user-friendly and flexible device for positioning several sheets in a stapler.

1. A device for positioning several sheets in a stapler (200), having a holder (101), a paper stop (111), which is retained by the holder (101), and an adjusting mechanism for adjusting the paper stop (111), characterized in that the holder (101) can be fitted on the stapler (200), and in that the adjusting mechanism is designed such that the paper stop (111) can be adjusted in relation to the holder (101).

2. The device as claimed in claim 1, characterized in that the adjusting mechanism comprises a latching mechanism for latching a plurality of predetermined latching positions between the paper stop (111) and the holder (101).

3. The device as claimed in claim 2, characterized in that the latching mechanism is formed by a resilient pressure-exerting component (110) on the holder (101) and a plurality of corresponding apertures (115, 116, 117) along the paper stop (111).

4. The device as claimed in one of claims 1 to 3, characterized by the adjusting mechanism being designed so as to allow optional adjustments of an angle between a border of a sheet positioned against the paper stop (111) and a stapling produced by the stapler (200), with a predetermined distance between the stapling and the sheet border.

5. The device as claimed in claim 4, characterized in that the paper stop (111) comprises the following:
a) an angular part (112) in the form of a segment of a circle;
b) a fastening arm (113), which extends radially inward in the plane of the angular part (112) from an angle bisector of the angular part (112) and which, at a center point of the circle, comprises means (114) for fastening the paper stop (111) in a rotatable manner on the holder (101);
c) two stop components (120, 121), which are arranged at ends of the angular part (112).

6. The device as claimed in claim 5, characterized in that latching elements (115, 116, 117) are arranged on the angular part (112) such that the angle between the stapling and the sheet border can be latched in at 0°, 45° and 90°.

7. The device as claimed in claim 5, characterized in that the angular part (112) is designed such that the segment of the circle extends over an angle of 210°-270°.

8. The device as claimed in claim 5, characterized in that the stop components (120, 121) extend vertically upward in a column-like manner from the angular part (112) and, on the paper side, are flattened for the purpose of guiding the sheets.

9. The device as claimed in claim 1, characterized by the holder (101) being designed such that it can be fastened on a conventional stapler (200).

10. The device as claimed in claim 9, characterized in that the holder (101) has a clamping element (104, 105) for fastening the device (100) on the conventional stapler (200).
